(19) United States
(12) Patent Application Publication
(10) Pub. No.: US 2004/0222930 A1
(43) Pub. Date: Nov. 11, 2004

(54) Wrist antenna

(76) Inventors: Huei-Hsin Sun, Taipei City (TW); Yu-Yu Chuang, Banchiau City (TW); Sheng-Ming Deng, Hsinchu (TW)

Correspondence Address: NIKOLAI & MERSEREAU, P.A., 900 SECOND AVENUE SOUTH, SUITE 820, MINNEAPOLIS, MN, 55402, US

(21) Appl. No.: 10/430,936

(22) Filed: May 7, 2003

(51) Int. Cl. H01Q 1/12

(52) U.S. Cl. 343/718

(57) ABSTRACT

A portable antenna assembly is disclosed. The assembly comprises a plurality of antenna elements spaced apart either around a bracelet or around a transparent covering of a watch, a dial surface of the watch, an outer surface of each link of a watchband, and an outer surface of each of two end snapping members of the watchband. The antenna elements are electrically coupled together. The assembly further comprises circuit means (e.g., IC) electrically coupled to either end antenna element. The antenna assembly is adapted to send and receive electromagnetic waves for carrying out a wireless communication with a device. Also, the antenna element can be implemented as a patch antenna, a metal piece antenna, a metal wire antenna, a PCB antenna, a ceramic antenna, a chip antenna, or a combination thereof.

### FIELD OF THE INVENTION

The present invention relates to antennas and more particularly to a wrist antenna with improved characteristics.

### BACKGROUND OF THE INVENTION

Conventionally, an antenna can be implemented in one of a variety of shapes. For example, a typical wide-band antenna implemented as a plane antenna 10 is received in a recess 201 on a back of a telecommunication device 20. A channel 202 is formed at a side of the recess 201 so that a wire can be connected from the antenna 10 to internal circuitry of the device via the channel 202. The device has a metal housing so that a minimum interference to the antenna 10 is caused by the circuitry. As a result, a good communication is obtained.

However, the prior art antenna suffered from a disadvantage. For example, its transmission or receiving angle is limited. Hence, it is hard for such antenna to be implemented as a slim, compact one readily mounted in one of a wide variety of telecommunication devices other than the above. Thus, the need for improvement still exists.

### SUMMARY OF THE INVENTION

It is therefore an object of the present invention to provide an antenna assembly comprising a plurality of antenna elements spaced apart around a portable member and electrically coupled together, and circuit means electrically coupled to either end antenna element wherein the antenna assembly is adapted to send and receive electromagnetic waves for carrying out a wireless communication with a device. The portable member can be a bracelet, a transparent covering of a watch, a dial surface of the watch, an outer surface of each link of a watchband, or an outer surface of each of two end snapping members of the watchband. Also, the antenna element can be implemented as a patch antenna, a metal piece antenna, a metal wire antenna, a PCB antenna, a ceramic antenna, a chip antenna, or a combination thereof.

The above and other objects, features and advantages of the present invention will become apparent from the following detailed description taken with the accompanying drawings.

### BRIEF DESCRIPTION OF THE DRAWINGS

FIG. 1 is a rear plan view of a conventional wide-band antenna mounted on a recess on a back of a telecommunication device;

FIG. 2 is a perspective view of a first preferred embodiment of antenna mounted in a bracelet according to the invention;

FIG. 3 is an exploded perspective view of a second preferred embodiment of antenna mounted in a watch according to the invention;

FIG. 4 is an environmental view of the watch mounted in the bracelet being worn on the wrist; and

FIG. 5 is another environmental view of the watch mounted in the bracelet being worn on the wrist.

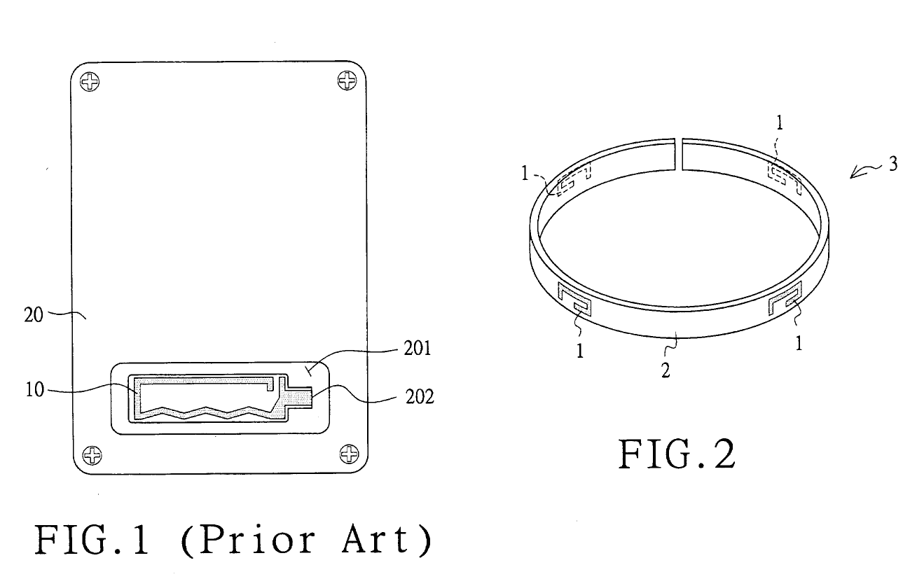

### DETAILED DESCRIPTION OF THE PREFERRED EMBODIMENTS

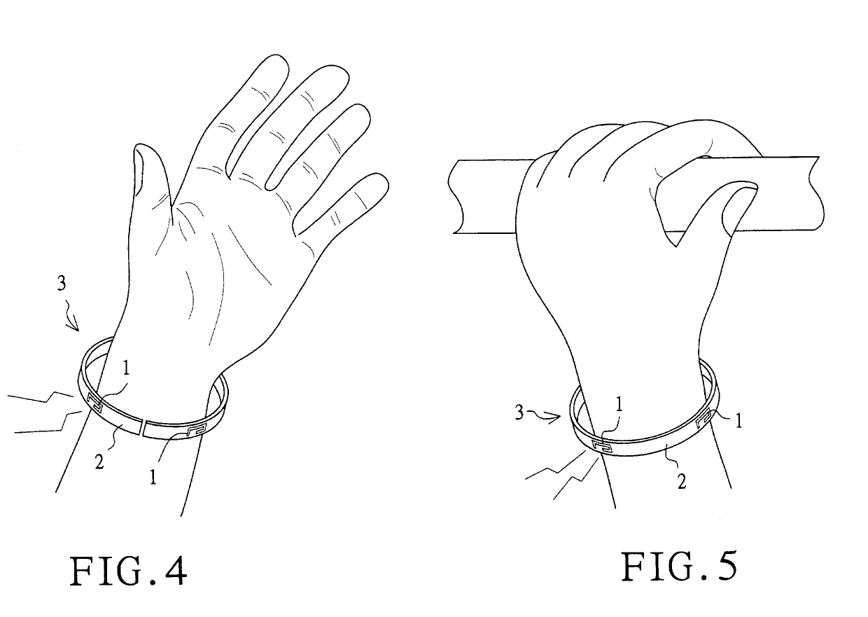

Referring to FIGS. 2, 4, and 5, there are shown a first preferred embodiment of the invention. As shown, an antenna assembly comprises a plurality of antenna elements 1 spaced apart around a bracelet 2. The antenna elements 1 are electrically coupled together by a wire (not shown) through the bracelet 2. Also, a circuit device implemented as an IC (integrated circuit) is electrically coupled to either end antenna element 1. This forms an antenna of the invention in a bracelet 2. A user can wear a bracelet 2 provided with the antenna on his/her wrist. The antenna is capable of sending electromagnetic waves from a telecommunication device carried by the user and receiving electromagnetic waves from outside.

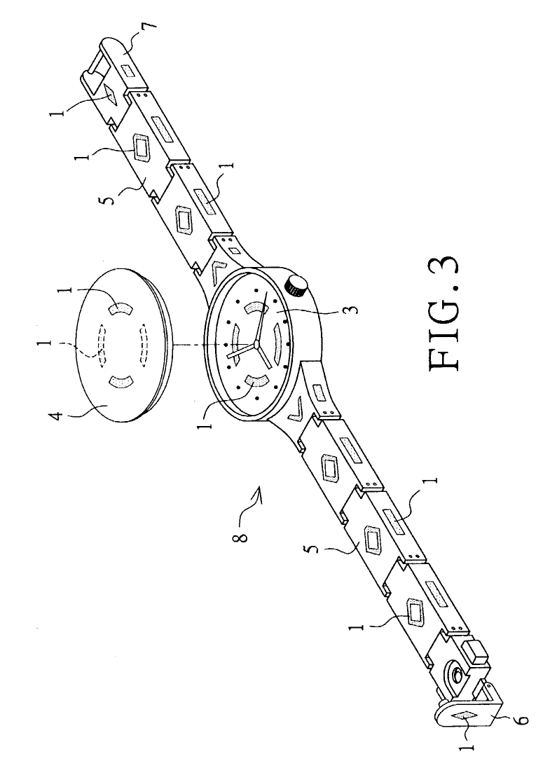

Referring to FIG. 3, there is shown a second preferred embodiment of the invention. As shown, an antenna assembly comprises a plurality of antenna elements 1 spaced apart around a transparent covering 4 of a watch 8, a dial surface 3 of the watch 8, an outer surface of each of a plurality of links 5 of a watchband, or an outer surface of each of two end snapping members 6 and 7 of the watchband. Also, the antenna elements 1 are electrically coupled together by a cable (not shown) through the watch 8. Also, a circuit device implemented as an IC (integrated circuit) is electrically coupled to either end antenna element 1. This forms an antenna of the invention in the watch 8. A user can wear a watch 8 provided with the antenna on his/her wrist. The antenna is capable of sending electromagnetic waves from a telecommunication device carried by the user and receiving electromagnetic waves from outside.

Moreover, the antenna element of the invention can be implemented as a patch antenna, a metal piece antenna, a metal wire antenna, a printed circuit board (PCB) antenna, a ceramic antenna, a chip antenna, or a combination thereof.

While the invention has been described by means of specific embodiments, numerous modifications and variations could be made thereto by those skilled in the art without departing from the scope and spirit of the invention set forth in the claims.

What is claimed is:

1. An antenna assembly, comprising a plurality of antenna elements spaced apart around a portable member and electrically coupled together, and circuit means electrically coupled to either end antenna element wherein the antenna assembly is adapted to send and receive electromagnetic waves for carrying out a wireless communication with a device.

2. The antenna assembly of claim 1, wherein the portable member is a bracelet.

3. The antenna assembly of claim 1, wherein the portable member is a transparent covering of a watch.

4. The antenna assembly of claim 1, wherein the portable member is a dial surface of a watch.

5. The antenna assembly of claim 1, wherein the portable member is an outer surface of each of a plurality of links of a watchband.

6. The antenna assembly of claim 1, wherein the portable member is an outer surface of each of two end snapping members of a watchband.

7. The antenna assembly of claim 1, wherein each of the antenna elements is a patch antenna, a metal piece antenna, a metal wire antenna, a printed circuit board (PCB) antenna, a ceramic antenna, a chip antenna, or a combination thereof.
